(19) United States
(12) Patent Application Publication
(10) Pub. No.: US 2017/0091673 A1
(43) Pub. Date: Mar. 30, 2017

(54) Exporting a Transformation Chain Including Endpoint of Model for Prediction

(71) Applicant: Skytree, Inc., San Jose, CA (US)

(72) Inventors: Abhishek Gupta, San Jose, CA (US); Alexander Gray, Santa Clara, CA (US); Nicholas Ball, San Bruno, CA (US); Sanjay Mehta, Fremont, CA (US); Terison Gregory, Dublin, CA (US); Troy Caldwell, San Jose, CA (US)

(21) Appl. No.: 15/279,843

(22) Filed: Sep. 29, 2016

Related U.S. Application Data
(60) Provisional application No. 62/234,588, filed on Sep. 29, 2015.

(51) Int. Cl. G06N 99/00; G06N 5/02

(52) U.S. Cl. CPC G06N 99/005; G06N 5/022

(57) ABSTRACT

A system and method for exporting a training model for performing a prediction including sending for presentation, to a user, a directed acyclic graph representing a model trained using a transformed source dataset and one or more transformations used to obtain the transformed source dataset; determining the model as an endpoint based on a user selection; determining a transformation as a start point; determining whether one or more intervening transformations exist on a path going from the start point and leading to the endpoint in the directed acyclic graph; and exporting the model and relevant transformations, the relevant transformations including the transformation at the start point and any intervening transformations on the path going from the start point and leading to the model at endpoint in the directed acyclic graph to a production environment.

### CROSS-REFERENCE FOR RELATED APPLICATIONS

The present application claims priority, under 35 U.S.C. §119, of U.S. Provisional Patent Application No. 62/234,588, filed Sep. 29, 2015 and entitled “Exporting a Transformation Chain Including Endpoint of Model for Prediction,” which is incorporated by reference in its entirety.

### BACKGROUND OF THE INVENTION

1. Field of the Invention

The present invention is related to exporting a trained model for generating predictions. More particularly, the present invention relates to systems and methods for exporting a transformation chain including an endpoint of a trained model to a production environment for generating a real time prediction on a live stream of data or batch prediction on data batches.

2. Description of Related Art

In a training environment, a set of transformations gets invoked on a training dataset before a model can be trained on it. The model is trained on the transformed data. Once, the model is trained and tested, it is then deployed to a production environment. However, the deployment of a model from the training environment to the production environment very rarely results in the model being able to generate correct predictions on incoming data. More often than not, the model will outright generate incorrect predictions. To remedy this problem, users that deployed the model spend significant amount of time preparing the data prior to feeding it to the model for generating predictions. At best, it is slow, tedious and inefficient process, which ultimately compromises model accuracy, prevents the achievement of real time predictions for the incoming live stream of data, prevents the achievement of efficient batch predictions for data batches, and delivers sub-optimal results. This is all exacerbated when the datasets are massive in the case of big data analysis.

Thus, there is a need for a system and method that describes a capability to export a portion of a transformation chain including an endpoint of a trained model to a production environment for generating a real time prediction on a live stream of data or batch prediction on data batches.

### SUMMARY OF THE INVENTION

The present invention overcomes the deficiencies of the prior art by providing a system and method for exporting a training model along with a portion of a transformation chain for performing a real time prediction on a live stream of data or batch prediction on data batches.

According to one innovative aspect of the subject matter described in this disclosure, a system comprises one or more processors; and a memory storing instructions that, when executed by the one or more processors, cause the system to: send for presentation, to a user, a directed acyclic graph representing a model trained using a transformed source dataset and one or more transformations used to obtain the transformed source dataset; determine the model as an endpoint based on a user selection; determine a transformation as a start point; determine whether one or more intervening transformations exist on a path going from the start point and leading to the endpoint in the directed acyclic graph; and export the model and relevant transformations, the relevant transformations including the transformation at the start point and any intervening transformations on the path going from the start point and leading to the model at endpoint in the directed acyclic graph to a production environment.

In general, another innovative aspect of the subject matter described in this disclosure may be embodied in methods that include sending for presentation, to a user, a directed acyclic graph representing a model trained using a transformed source dataset and one or more transformations used to obtain the transformed source dataset; determining the model as an endpoint based on a user selection; determining a transformation as a start point; determining whether one or more intervening transformations exist on a path going from the start point and leading to the endpoint in the directed acyclic graph; and exporting the model and relevant transformations, the relevant transformations including the transformation at the start point and any intervening transformations on the path going from the start point and leading to the model at endpoint in the directed acyclic graph to a production environment.

Other aspects include corresponding methods, systems, apparatus, and computer program products for these and other innovative features.

For instance, the features may include: the model and the relevant transformations are converted, as part of the export process, to real-time streaming; the model is trained in batch mode and the production environment operates in one of batch mode and real-time streaming mode; wherein the model and relevant transformations including the transformation at the start point and any intervening transformations on the path going from the start point and leading to the model at endpoint in the directed acyclic graph is less than the entirety of a workflow represented by the directed acyclic graph; validating one or more of the relevant transformations; validating a precondition and post condition of the transformation of each relevant transformation.

For instance the operations further include: determining an additional transformation as an additional start point; and determining whether one or more additional, intervening transformations exist on a path going from the additional start point and leading to the endpoint in the directed acyclic graph, wherein the relevant transformations that are exported include the additional start point and any additional, intervening transformations leading from the additional start point to the model at the endpoint.

For instance the operations further include: determining a subset of variables associated with one or more of a first transformation, an intervening transformation and a model that should be fixed for use in the production environment; and setting the variable to the fixed value when exporting the model and relevant transformations.

The present invention is particularly advantageous because it facilitates deployment of a model and corresponding transformation(s) to a production environment.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a block diagram illustrating an example of a system for exporting from a training environment a transformation chain including an endpoint of a trained model to a production environment for prediction in accordance with the one implementation of the present disclosure.

FIG. 2 is a block diagram illustrating an example of a training server in accordance with one implementation of the present disclosure.

FIG. 3 is a block diagram illustrating an example of a prediction server in accordance with one implementation of the present disclosure.

FIG. 4 is a graphical representation of an example of a directed acyclic graph representing a transformation workflow resulting in a trained model.

FIG. 5 is a graphical representation of an example of a user interface displaying a list of transformation workflow projects according to one embodiment.

FIG. 6 is a graphical representation of an example of a user interface displaying a directed acyclic graph view of a selected transformation workflow according to one embodiment.

FIG. 7 is a graphical representation of an example of a user interface for creating an exportable model according to one embodiment.

FIG. 8 is a graphical representation of an example of a user interface displaying a scoring dashboard according to one embodiment.

FIG. 9 is a flowchart of an example method for exporting of a portion of a transformation chain including an endpoint of a trained model to a production environment for prediction according to one embodiment.

FIG. 10 is a flowchart of an example method for deploying a transformation chain including an endpoint of a trained model in a production environment for prediction according to one embodiment.

FIG. 11 is a graphical representation of an example of a user interface displaying a scoreboard according to one embodiment.

### DETAILED DESCRIPTION

A system and method for enabling exporting of a transformation chain including an endpoint of a trained model to a production environment for prediction is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to particular hardware and software embodiments. However, the present invention applies to other types of implementations distributed in the cloud, over multiple machines, using multiple processors or cores, using virtual machines, appliances or integrated as a single machine.

The term embodiment and implementation are used interchangeably herein. Reference in the specification to “one implementation” or “an implementation” or “one embodiment” or “an embodiment” means that a particular feature, structure, or characteristic described in connection with the embodiment is included in at least one implementation/embodiment of the invention. The appearances of the phrases “in one implementation” or “in one embodiment” in various places in the specification are not necessarily all referring to the same implementation or embodiment. In particular the present invention is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is described without reference to any particular programming language. It will be appreciated that a variety of programming languages may be used to implement the teachings of the invention as described herein.

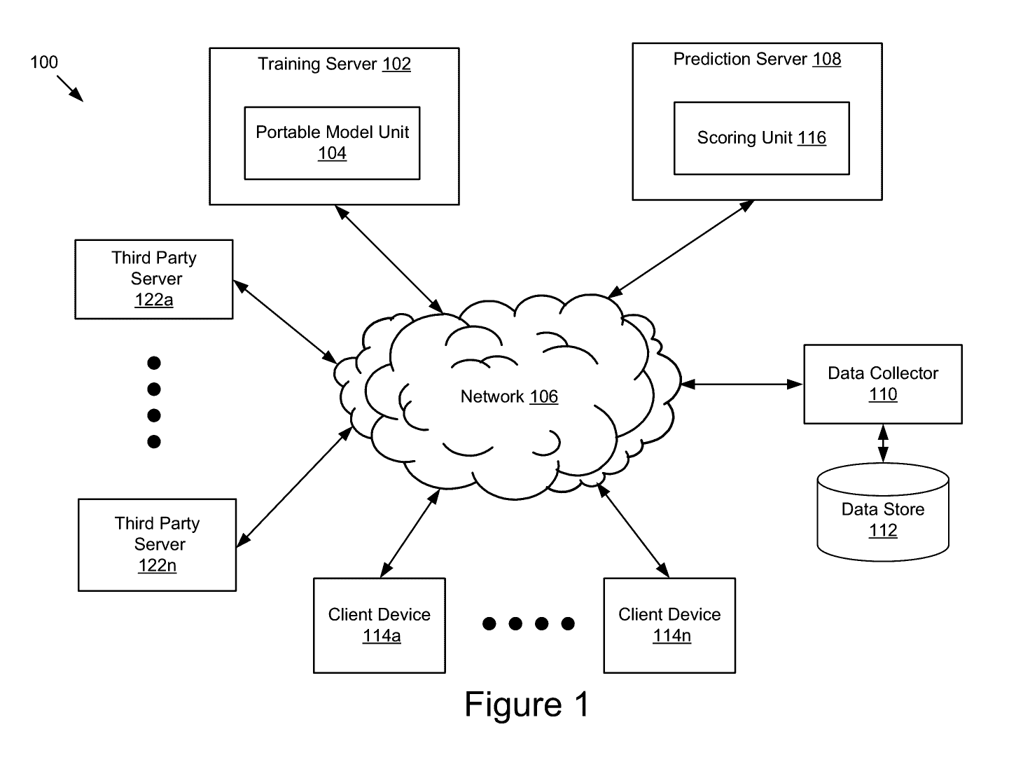

FIG. 1 shows an embodiment of a system 100 for exporting from a training environment a transformation chain including an endpoint of a trained model to a production environment for prediction. In the depicted embodiment, the system 100 includes a training server 102, a plurality of client devices 114a . . . 114n, a prediction server 108, a data collector 110 and associated data store 112, and a plurality of third party servers 122a . . . 122n. In FIG. 1 and the remaining figures, a letter after a reference number, e.g., “114a,” represents a reference to the element having that particular reference number. A reference number in the text without a following letter, e.g., “114,” represents a general reference to instances of the element bearing that reference number. In the depicted embodiment, these entities of the system 100 are communicatively coupled via a network 106.

In some implementations, the system 100 includes a training server 102 coupled to the network 106 for communication with the other components of the system 100, such as the plurality of client devices 114a . . . 114n, the prediction server 108, the data collector 110 and associated data store 112, and a plurality of third party servers 122a . . . 122n. In some implementations, the training server 102 may be either a hardware server, a software server, or a combination of software and hardware. In the example of FIG. 1, the components of the training server 102 may be configured to implement portable model unit 104 described in more detail below. In some implementations, the training server 102 provides services to data analysis customers by facilitating an export of at least a portion of the transformation workflow including a model to a prediction server 108 for prediction. For example, the training server 102 receives a selection of a transformation workflow from a user, creates a portable model object for export and stores the portable model object as a child object of the transformation workflow in the storage device 212. In some embodiments, the training server 102 provides services to data analysis customer for creating the transformation chain for export to the production environment (e.g. prediction server 108). For purposes of this application, the terms “transform,” “transformation” and “transform operation” are used interchangeably to mean the same thing, namely, a transformation used in the analysis of one or more datasets. For the purposes of this application, the terms “transformation workflow,” “transformation chain,” “ETL pipeline,” “transformation pipeline” and similar terms are used interchangeably to mean the same thing, namely, a sequence of transformations invoked to prepare data for training a model. Although only a single training server 102 is shown in FIG. 1, it should be understood that there may be any number of training servers 102 or a server cluster.

In some implementations, the prediction server 108 may be either a hardware server, a software server, or a combination of software and hardware. In the example of FIG. 1, the components of the prediction server 102 may be configured to implement scoring unit 116 described in more detail below. In some implementations, the prediction server 108 receives a portable model from the training server 102, deploys the portable model to process data and provide predictions prescribed by the portable model. For purposes of this application, the terms “prediction” and “scoring” are used interchangeably to mean the same thing, namely, to turn predictions (in batch mode or online) using the portable model. Although only a single prediction server 108 is shown in FIG. 1, it should be understood that there may be a number of prediction servers 108 or a server cluster.

The third party servers 122a . . . 122n may be associated with one or more entities that generate and send models and transformation chains to the training server 102 and/or prediction server 108. Examples of such entities include, but are not limited to, extract, transform and load (ETL) vendors, machine learning libraries and machine learning enterprise companies (e.g. Skytree, Apache Spark, Spark MLLib, Python, R, SAS, etc.). It should be recognized that the preceding are merely examples of entities which may generate models and transformations and that others are within the scope of this disclosure. In some embodiments, the training server may facilitate the creation of the transformation chains and models.

The servers 102, 108 and 122 may each include one or more computing devices having data processing, storing, and communication capabilities. For example, the servers 102, 108 and 122 may include one or more hardware servers, server arrays, storage devices and/or systems, etc. In some implementations, the servers 102, 108 and 122 may include one or more virtual servers, which operate in a host server environment and access the physical hardware of the host server including, for example, a processor, memory, storage, network interfaces, etc., via an abstraction layer (e.g., a virtual machine manager). In some implementations, one or more servers 102, 108 and 122 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106 (e.g., the data collector 110, the client device 114, etc.).

The data collector 110 is a server/service which collects data and/or analysis from other servers (not shown) coupled to the network 106. In some implementations, the data collector 110 may be a first or third-party server (that is, a server associated with a separate company or service provider), which mines data, crawls the Internet, and/or receives/retrieves data from other servers. For example, the data collector 110 may collect user data, item data, and/or user-item interaction data from other servers and then provide it and/or perform analysis on it as a service. In some implementations, the data collector 110 may be a data warehouse or belonging to a data repository owned by an organization.

The data store 112 is coupled to the data collector 108 and comprises a non-volatile memory device or similar permanent storage device and media. The data collector 110 stores the data in the data store 112 and, in some implementations, provides access to the training server 102 and/or the prediction server 108 to retrieve the data collected by the data store 112. Although only a single data collector 110 and associated data store 112 is shown in FIG. 1, it should be understood that there may be any number of data collectors 110 and associated data stores 112. In some implementations, there may be a first data collector 110 and associated data store 112 accessed by the training server 102 and a second data collector 110 and associated data store 112 accessed by the prediction server 108.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, WAP, email, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the training server 102 may receive a selection of a transformation workflow from and/or serve transformation workflow information to a multiplicity of users on a multiplicity of client devices 114a . . . 114n. In some implementations, the plurality of client devices 114a . . . 114n may support the use of Application Programming Interface (API) calls to the training server 102 and/or the prediction server 108 allowing the multiplicity of users to interact with REST API and software development kit (SDK) built upon the REST API to export and/or deploy a model.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different embodiments of the system 100 that include the network 106, the training server 102 having a portable model unit 104, the prediction server 108 having a scoring unit 116, the data collector 110 and associated data store 112, one or more client devices 114 and one or more third party servers 122. In a first example, the one or more servers 102, 108 and 122 may each be dedicated devices or machines coupled for communication with each other by the network 106. In a second example, any one or more of the servers 102, 108 and 122 may each be dedicated devices or machines coupled for communication with each other by the network 106 or may be combined as one or more devices configured for communication with each other via the network 106. For example, the training server 102 and the prediction server 108 may be included in the same server. In a third example, any one or more of the servers 102, 108 and 122 may be operable on a cluster of computing cores in the cloud and configured for communication with each other. In a fourth example, any one or more of one or more servers 102, 108 and 122 may be virtual machines operating on computing resources distributed over the internet. In a fifth example, any one or more of the servers 102, 108 and 122 may each be dedicated devices or machines that are firewalled or completely isolated from each other (i.e., the servers 102, 108 and 122 may not be coupled for communication with each other by the network 106). For example, the training server 102 and the prediction server 108 may be included in different servers that are firewalled or completely isolated from each other.

While the training server 102 and the prediction server 108 are shown as separate devices in FIG. 1, it should be understood that in some embodiments, the training server 102 and the prediction server 108 may be integrated into the same device or machine. Particularly, where they are performing online learning, a unified configuration may be preferred. While the system 100 shows only one device 102, 106, 108, 110 and 112 of each type, it should be understood that there could be any number of devices of each type. Moreover, it should be understood that some or all of the elements of the system 100 could be distributed and operate in the cloud using the same or different processors or cores, or multiple cores allocated for use on a dynamic, as needed, basis. Furthermore, it should be understood that the training server 102 and the prediction server 108 may be firewalled from each other and have access to separate data collector 110 and associated data store 112. For example, the training server 102 and the prediction server 108 may be in a network isolated configuration.

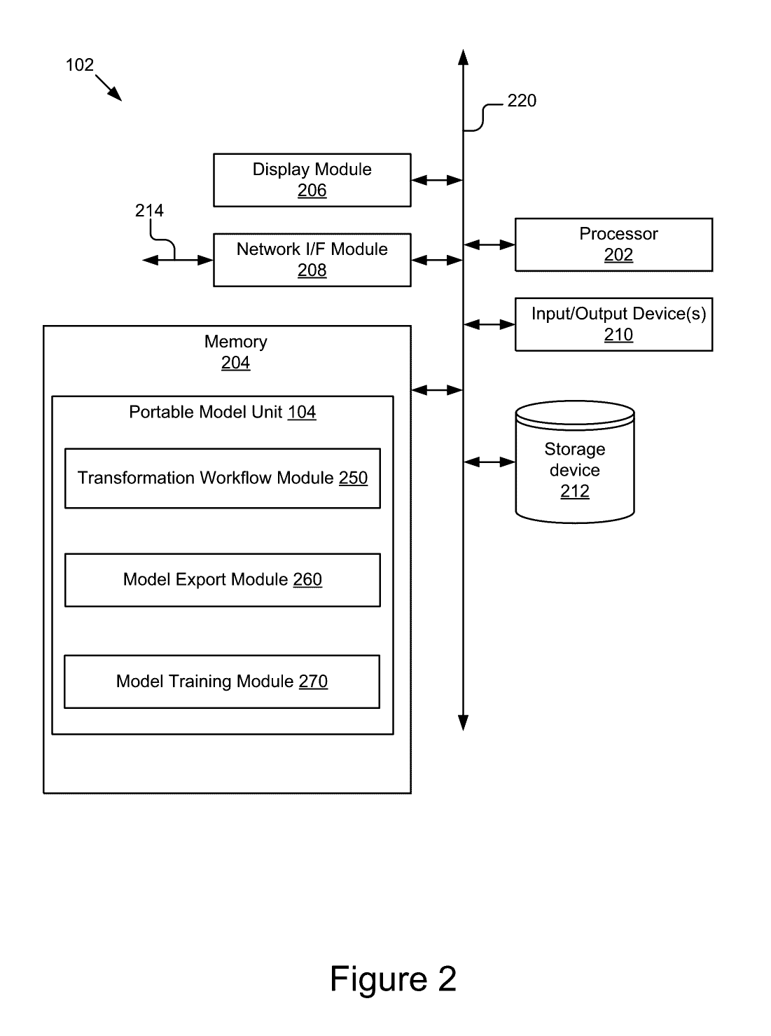

Referring now to FIG. 2, an embodiment of a training server 102 is described in more detail. The training server 102 comprises a processor 202, a memory 204, a display module 206, a network I/F module 208, an input/output device 210 and a storage device 212 coupled for communication with each other via a bus 220. The training server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the training server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. In some implementations, the processor(s) 202 may be coupled to the memory 204 via the bus 220 to access data and instructions therefrom and store data therein. The bus 220 may couple the processor 202 to the other components of the training server 102 including, for example, the display module 206, the network I/F module 208, the input/output device(s) 210, and the storage device 212.

The memory 204 may store and provide access to data to the other components of the training server 102. The memory 204 may be included in a single computing device or a plurality of computing devices. In some implementations, the memory 204 may store instructions and/or data that may be executed by the processor 202. For example, as depicted in FIG. 2, the memory 204 may store the portable model unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of training server 102.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the training server 102. It should be understood that the memory 204 may be a single device or may include multiple types of devices and configurations.

The display module 206 may include software and routines for sending processed data, analytics, or results for display to a client device 114, for example, to allow an administrator to interact with the training server 102. In some implementations, the display module may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. The network I/F module 208 also provides other conventional connections to the network 106 for distribution of files using standard network protocols such as TCP/IP, HTTP, HTTPS and SMTP as will be understood to those skilled in the art. In an alternate embodiment, the network I/F module 208 is coupled to the network 106 by a wireless connection and the network I/F module 208 includes a transceiver for sending and receiving data. In such an alternate embodiment, the network I/F module 208 includes a Wi-Fi transceiver for wireless communication with an access point. In another alternate embodiment, network I/F module 208 includes a Bluetooth® transceiver for wireless communication with other devices. In yet another embodiment, the network I/F module 208 includes a cellular communications transceiver for sending and receiving data over a cellular communications network such as via short messaging service (SMS), multimedia messaging service (MMS), hypertext transfer protocol (HTTP), direct data connection, WAP, email, etc. In still another embodiment, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the training server 102 and can be coupled to the system either directly or through intervening I/O controllers. The I/O devices 210 may include a keyboard, mouse, camera, stylus, touch screen, display device to display electronic images, printer, speakers, etc. An input device may be any device or mechanism of providing or modifying instructions in the training server 102. An output device may be any device or mechanism of outputting information from the training server 102, for example, it may indicate status of the training server 102 such as: whether it has power and is operational, has network connectivity, or is processing transactions.

The storage device 212 is an information source for storing and providing access to data, such as a plurality of datasets, transformations and transformation workflow associated with the plurality of datasets (e.g. for training and/or scoring depending on the embodiment). The data stored by the storage device 212 may be organized and queried using various criteria including any type of data stored by it. The storage device 212 may include data tables, databases, or other organized collections of data. The storage device 212 may be included in the training server 102 or in another computing system and/or storage system distinct from but coupled to or accessible by the training server 102. The storage device 212 can include one or more non-transitory computer-readable mediums for storing data. In some implementations, the storage device 212 may be incorporated with the memory 204 or may be distinct therefrom. In some implementations, the storage device 212 may store data associated with a database management system (DBMS) operable on the training server 102. For example, the RDBMS could include a structured query language (SQL) relational DBMS, a NoSQL DBMS, various combinations thereof, etc. In some instances, the DBMS may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the training server 102. The bus 220 can include a communication bus for transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the training server 102 (operating systems, device drivers, etc.), and any of the components of the portable model unit 104 may cooperate and communicate via a communication mechanism included in or implemented in association with the bus 220. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the portable model unit 104 may include and may signal the following to perform their functions: a transformation workflow module 250, a model export module 260, and a model training module 270.

The transformation workflow module 250 includes computer logic executable by the processor 202 to receive a selection of a portion of a transformation workflow including an endpoint of a model. The transformation workflow, which may also occasionally be referred to herein as a transformation pipeline, project workflow or similar, includes one or more transformations invoked on the dataset that is used in training of the model. In some implementations, the transformation workflow may include an iteration at a level between the datasets and models. For example, the transformation workflow can be a mixture of an expert's model setup and feature generation/selection performed inside a cross-validation structure. In some implementations, the one or more transformations may include machine learning specific transformations for data transformation. For example, the machine learning specific transformations include Normalization, Horizontalization (i.e., one-hot encoding), Moving Window Statistics, Text Transformation, supervised learning, unsupervised learning, dimensionality reduction, density estimation, clustering, etc. In some implementations, the one or more transformations may include functional transformations that take multiple columns of the dataset as inputs and produce another column as output. For example, the functional transformations may include addition transformation, subtraction transformation, multiplication transformation, division transformation, greater than transformation, less than transformation, equals transformation, contains transformation, etc. for the appropriate types of data columns. In some implementations, the one or more transformations can take one or more input datasets (or dataframes, which are in-memory representations of datasets) and transform them into one or more output datasets (or dataframes). In some implementations, the one or more transformations may include custom transformations developed in one or more programming languages by users. For example, the programming platforms that may be used to develop transformations by users include, but are not limited to SAS™, Python™, Apache Spark™, PySpark, R, SciPy, Java™ Scala, etc. In some implementations, a custom transformation may be a script. For example, a custom transformation may include, or be authored as, a Python™ script including one or more transformation steps. In another example, a custom transformation may be defined in the form of a transform snippet. A transform snippet may be defined with one or more input parameters, one or more output parameters, and core logic for the custom transformation steps represented. In one embodiment, the transformation workflow module 250 determines the transformation and generates the glue logic for the transformation automatically (i.e. the user does not need to manually code the glue logic to manipulate inputs and outputs) based on the defined input(s) and output(s). Depending on the type of custom transformation the one or more parameters may vary. For example, the transformation may transform data and the parameters may include one or more of a column, a dataset, a function to be performed on a column or dataset (e.g. perform a mathematical operation on one or more columns, a hold-out for cross-validation, etc.). In another example, the transformation may include one or more of a machine learning model (e.g. supervised or unsupervised) and parameter(s) for the model. In another example, the transformation may include a result, a report a plot, or some other transformation, and the transform includes parameters associated therewith (e.g. an axis and a label for a plot). The transform snippet may be a reusable piece of parameterized code for performing the custom transform(s). In one implementation, a user may select a programming language in which the transform snippet is authored. In some implementations, the transformation workflow module 250 may receive a request to delete models and/or datasets in the transformation workflow to update the portion of the transformation workflow.

In some implementations, the model in the transformation workflow is a machine learning model and that model may be trained, tuned and tested. For example, the machine learning model can include, but is not limited to, gradient boosted trees (GBT), gradient boosted trees for regression (GBTR) support vector machines (SVM), random decision forest (RDF), random decision forest for regression (RDFR), generalized linear model for classification (GLMC), generalized linear model for regression (GLMR), AutoModel classifier, AutoModel regressor, etc.

In some implementations, the transformation workflow module 250 is coupled to the storage device 212 to access one or more transformation workflows and datasets. Each transformation workflow may include metadata associated with it such as workflow name/ID, model name/ID, creation timestamp, dataset name/ID, transformation steps, etc. In some implementations, the transformation workflow module 250 receives a selection of a transformation workflow from one or more transformation workflows. The transformation workflow module 250 determines a sequence of transformations that have been applied to the dataset from the beginning in the transformation workflow. For example, the transformation workflow includes a history of user actions in the form of transformations that have been invoked on the dataset and presents an evolution of the transformation workflow thereby facilitating auditing of the transformation workflow. The transformation workflow module 250 generates instructions for a visual representation of the transformation workflow in the form of a directed acyclic graph (DAG) view according to one embodiment. The DAG view tracks the execution history (i.e., date, time, etc.) of various transformations applied to the dataset in the transformation workflow. For example, the DAG view may simplify the audit trail of the data flow and transformation sequence through the transformation workflow at different points.

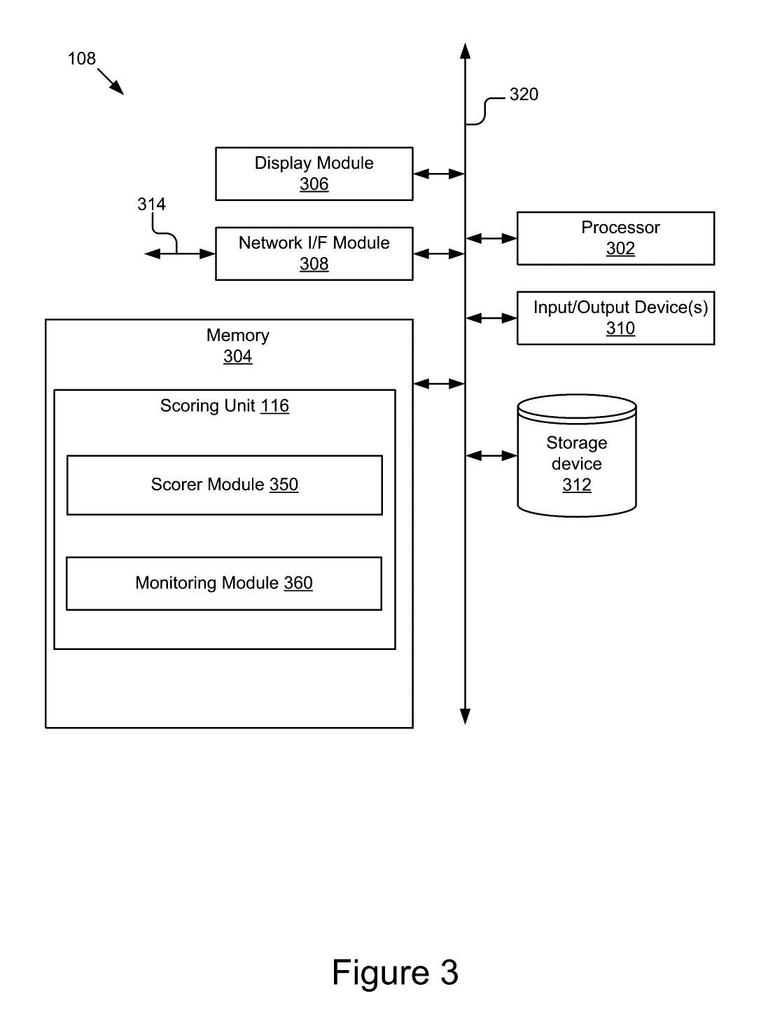

In some implementations, the transformation workflow module 250 may receive a request to select a DAG of the transformation workflow, or a portion thereof leading up to the endpoint of a model in the transformation workflow. The transformation workflow module 250 receives a first selection of a start node (transformation) in the DAG of the transformation workflow and a second selection of a model (machine learning model) as the end node where the start node leads to the creation of the model in the DAG of the transformation workflow. In some implementations, the DAG view of the transformation workflow can be manipulated by the user to select one or more transformation as the start node(s) and a model as the end node. For example, in one implementation, the transformation workflow module 250 receives a selection of the portion of the transformation workflow including the model via a user interface such as the one discussed below with reference to FIG. 3. In some implementations, the transformation workflow module 250 receives a selection of more than one node in the DAG of the transformation workflow as start nodes that lead to the creation of the model. For example, there may be two nodes, transformation node A and transformation node B in the DAG of the transformation workflow that are start nodes that lead to the creation of the model.

In some implementations, the transformation workflow module 250 receives a selection of a model in the transformation workflow as an endpoint. The transformation workflow module 250 determines the source of the transformation workflow by tracing back from the selected model and automatically selects the one or more intervening transformations between the selected model and the source. Depending on the embodiment and/or the user's interaction, a user may select an endpoint first and then one or more start points or one or more start points and then an endpoint (e.g. an endpoint common to the one or more start nodes). In some embodiments, a start node and/or intervening node may also be associated with a model, i.e., in some embodiments, the endpoint may not be the only node associated with a model.

In one embodiment, when the user selects an end node, the transformation workflow module 250 traces back to the source and to identify nodes that lead to that end node as candidates for selection as the one or more start nodes. In one embodiment, when the user selects one or more start nodes, the transformation workflow module 250 traces to models at the end of the workflow and identifies model nodes along the traced path(s) as candidates for selection as the end node (e.g. by visually distinguishing the nodes to the user). It should be recognized that while the description herein refers to nodes as representing transforms and/or models, other representations are contemplated and within the scope of this disclosure. For example, in some embodiments, an edge in the DAG may represent a model and/or transform.

In some implementations, the transformation workflow module 250 retrieves a file format describing the model that is stored in association with the model included in the transformation workflow. For example, the file format may include one from the group of the binary file format, Predictive Model Markup Language (PMML) file format, etc. In some implementations, the transformation workflow module 250 sends the file of the selected model and the one or more transformations that lead up to the endpoint of the model in the DAG to the model export module 260.

The model export module 260 includes computer logic executable by the processor 202 to receive the selection of the portion of the transformation workflow including the endpoint of the model, to perform validation on the portion of the transformation workflow and to create a portable model for exporting to the prediction server 108. In some implementations, the model export module 260 is coupled to the storage device 212 to access one or more transformation workflows, to retrieve transformation and model metadata for validating the portion of the transformation workflow and to export the portable model to the prediction server 108.

For the purposes of this disclosure, the term “portion, “portion of the transform,” “portion of the transform chain,” “portion of the transformation pipeline” and similar are used interchangeably to refer to the portion of the transformation workflow including the one or more start nodes, the end node and the intervening nodes between the start nodes and end nodes. Depending on one or more of the embodiments, the transformation pipeline and user's input, the portion of the transformation pipeline may be less than the entirety of the transformation pipeline or the entirety of the transformation pipeline.

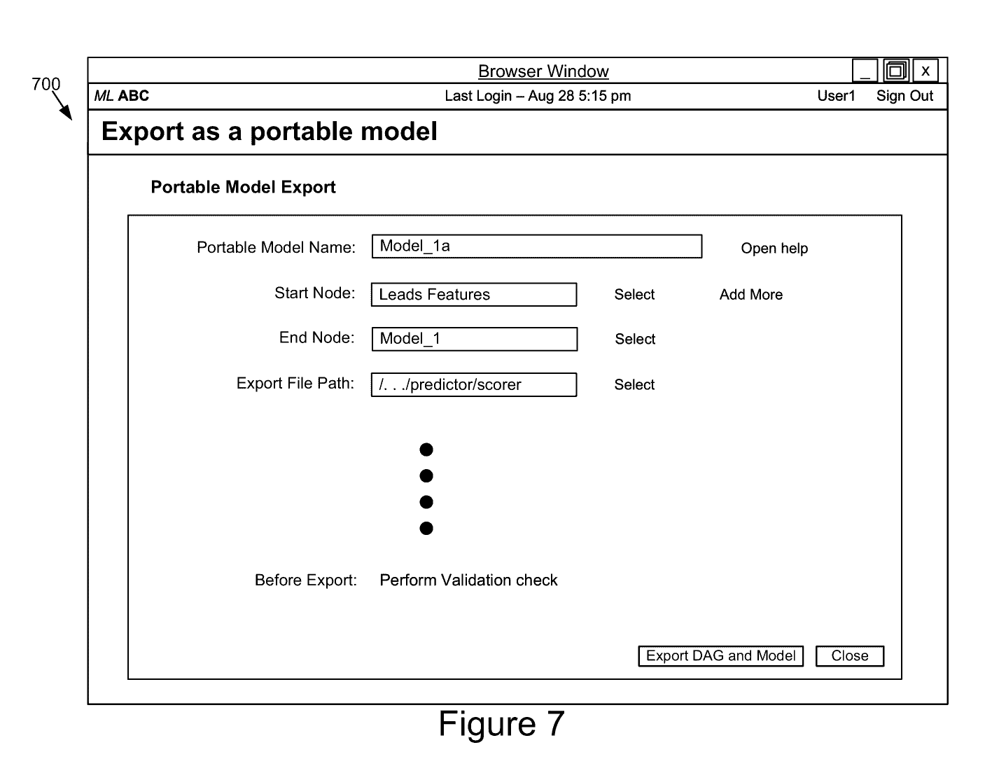

In some implementations, the model export module 260 receives the selection of the portion of the transformation workflow including the endpoint of the model from the transformation workflow module 250. The model export module 260 receives a name for the portion of the transformation workflow including the model to be exported, an export file path (to the prediction server 108 or to an intermediate storage device in the embodiment where the prediction server 108 is network isolated from the training server 102) and an identification of two or more DAG nodes in the transformation workflow (where one DAG node is the model reachable from one or more other DAG nodes (start nodes), each node representing a transformation). In some implementations, the identity of the DAG node may include a name and/or ID of the dataset, a name and/or ID of the model, result produced by the DAG node, etc. In one implementation, the model export module 260 receives information for exporting the portion of the transformation workflow including the model via a user interface such as the one discussed below with reference to FIG. 7.

In some implementations, the model export module 260 analyzes the transformation workflow for evaluating the validity of the transformation workflow before exporting it as part of the portable model to the prediction server 108. In some implementations, the model export module 260 validates whether the end node of the transformation workflow is a model. For example, the transformation workflow may not end at a model. For example, the model output may serve as input and connect to another transformation in the transformation workflow that generates report(s) and/or plot(s), but the model export module 260 ensures that the portion of the transformation pipeline to be exported ends at a node associated with a model. In some implementations, the model export module 260 validates whether the model is in a file format that is exportable to and consumable by the prediction server 108. For example, in one embodiment, if the model file format is not in the Predictive Model Markup Language (PMML) file format, the model export module 260 generates a PMML file describing the model and associates the PMML file as metadata.

In some implementations, the model export module 260 validates whether each transformation in the transformation workflow is exportable to the prediction server 108. If the validation fails, the model export model 260 rejects exporting the transformation workflow as part of the portable model. In some implementations, the model export module 260 determines whether the one or more transformations in the transformation workflow are user developed transformations, and if so, the model export module 260 retrieves the user developed transformation included in the portion of the transformation workflow and packages it to be a part of the portable model. In some implementations, the model export module 260 identifies a set of preconditions and post conditions, for example, a list of input and output datasets (columnar data or features) expected as inputs and outputs of the user developed transformation for linking the node representing the user developed transformation to other nodes in the DAG of the transformation workflow.

In some implementations, the model export module 260 retrieves parameter data associated with the one or more transformations in the transformation workflow and packages the parameter data to be part of the portable model. This is done so that the transformation can be reasonably applied in the production environment. For example, a text transformation may require a feature vector. The model export module 260 retrieves the feature vector and associates it with the text transformation as part of the portable model. In another example, a sliding window transformation may have an associated window parameter. The model export module 260 retrieves the sliding window parameter and associates it with the sliding window transformation as part of the portable model.

In some implementations, the model export module 260 validates whether one or more transformations have an expected structure (e.g., module definition in Python™) and implement an expected transformation (e.g., batch transformation and single point transformation). For example, the model export module 260 may check whether a user developed transformation within the transformation workflow operates on a per data point basis (row of the dataset.) If so, the model export module 260 can validate that the transformation being part of the transformation workflow can be exportable and deployable in the prediction server where live data is streamed in a row (or data point) at a time.

In some implementations, the model export module 260 validates whether the model as the end node is reachable from the start node of the transformation workflow. For example, the transformation workflow may have more than one model and the model export module 260 checks that the right model which was selected as the end node is reachable from the start node. In some implementations, the model export module 260 traverses back from the model in the transformation workflow and determines the transformations that are important to the model and needed for the model to be reachable from the start node of the transformation workflow. The model export module 260 may omit a transformation that is found not important to the model from the transformation workflow (e.g. does not lead from a start node to the end node) depending on the embodiment. For example, the transformation workflow may include transformations that are report and/or plot transformations. Such transformations may be in the transformation workflow for auditing the transformation workflow at specific junctures in the evolution of the transformation workflow. The model export module 260 may omit the report and/or plot transformations from the transformation workflow depending on the embodiment. In another example, the model export module 260 may provide information to the user regarding the presence of non-useful transformations in the transformation workflow (e.g., “Your transformation workflow includes a plot transform which is not important to generating predictions.”) The user then can choose to include or omit the transformation from the transformation workflow before exporting the transformation workflow to the prediction server 108.

In some implementations, the model export module 260 retrieves sample input data (e.g. data similar to that to be received in the production environment) to feed to the portion of the transformation workflow being exported and to validate the results of the transformation workflow before exporting the transformation workflow to the prediction server 108. The validation may be a result validation (e.g. validating that a result is obtainable from the sample input data and, e.g. no critical transformation or information is omitted from the portion to be exported) and/or a performance validation (e.g. validating that an end-to-end prediction time .criteria is met). For example, the model export module 260 determines end-to-end scoring time for the sample input data. The model export module 260 validates the transformation workflow including the endpoint of the model eligible for export if the end-to-end scoring is within threshold limits.

In some implementations, the model export module 260 generates the portable model for exporting to the prediction server 108 responsive to the validating the transformation workflow including the endpoint of the model. The model export module 260 changes all references in the portable model to the test environment in order to reflect the production environment. In some implementations, the portable model may be an archive file (e.g. ZIP file) including the portion of transformation workflow between the start node and model, names of the one or more transformations in the transformation workflow, the custom user developed transformations, the datasets and existing/estimated parameter values associated with all transformations (e.g. when the transformation is a machine learning algorithm) in the transformation workflow and the PMML file of the model. In some implementations, the model export module 260 identifies the portable model as a child of the parent transformation workflow (from which it was derived) in the storage device 212. In one embodiment, the model export module 260 receives information relating to the portable model including name, start node, model name/ID, export timestamp, export filename, etc. and associates the information with the portable model in the storage device 212. In some implementations, the model export module 260 generates the portable model including the transformation workflow and stores in an intermediate storage device. The portable model and the transformation workflow is accessed from the intermediate storage device and imported into a network where the prediction server 108 resides. For example, in the embodiment where the training server 102 and the prediction server 108 are network isolated from each other, the import and/or export of the transformation workflow and the portable model is explicit and may include the use of the intermediate storage device.

In some implementations, the model export module 260 generates a non-portable model. In the embodiment where the training server 102 and the prediction server 108 may be implemented as a unified system configuration, the model export module 260 implements the non-portable model by generating a pointer to the portion of the transformation workflow leading up to the endpoint of the model and sending the pointer as a logical export to the production environment. This is distinct from the portable model because there is no physical export of the portion of the transformation workflow in the form of archive file to the production environment. However, it should be recognized that a non-portable model may be similar to a portable model in other regards, e.g., a non-portable model may have the pre and post conditions of the relevant transformations validated similar to a portable model.

In some implementations, the model export module 260 converts a transform from batch mode to online mode. Online mode may also be referred to as “real-time,” “streaming,” “single point,” or similar. For example, in some implementations, the model may be trained on a batch of data (e.g. data of multiple users), but is intended to make predictions for individual users in real-time or near real-time in the production environment. In some implementations, the model export module 260 converts what was a variable in a transform into a fixed value when exporting the relevant transforms. Examples of variables may include but are not limited to columns (e.g. the names of the columns that produced the exported model in a feature selection transformation), an input parameter for the model, an input parameter for a transform, a dictionary dataset, an input dataset, etc.

The model training module 270 includes computer logic executable by the processor 202 to perform automatic training and exporting new portable models for replacing existing models scoring predictions at the prediction server 108. In some implementations, the model training module 270 is coupled to the model export module 260 to package the training portable models for exporting to the prediction server 108.

In some implementations, the model training module 270 instructs the model export module 260 to export one or more portable models in training. In some implementations, the model training module 270 automatically trains and exports updated models to the prediction server 108. The model training module 270 receives a selection of an update schedule for automatically training and exporting an updated model to the prediction server 108. For example, the schedule may include but not limited to every hour, every day, every week, every month, every quarter, etc. In some implementations, the model training module 270 receives aggregated statistics for the deployed model from the prediction server 108. In other implementations where the training server 102 and the prediction server 108 are network isolated, the aggregated statistics may be stored in a separate data store. In such cases, an explicit export and/or import of the statistics may be necessary or an explicit trigger of the model updating may be necessary. For example, the statistics gathered during the deployment of the one or more portable models include but not limited to: a number of data points received, a number of data points scored, a number of data points scored grouped by score, average transformation time duration, maximum transformation time duration, average scoring time duration, maximum scoring time duration, rate of scoring (prediction count/minute or hour or day), distribution of input point values, distribution of output prediction values, time latency delta, input/output count delta, model variable importance of champion model versus newly trained model, etc. In some implementations, the model training module 270 identifies a rule associated with training and exporting the updated model to the prediction server 108. For example, the rule may designate that if degradation in observed statistics associated with a deployed portable model in scoring predictions exceeds a threshold, then model training module 270 may train and export an updated model.

In some implementations, the model training module 270 generates an updated model by retraining a model completely in batch based on the past data points. For example, the past data points may be data points for the past three months. The model training module 270 retrains in batch based on the three month period of data points. In some implementations, the model training module 270 incrementally updates the previous model based on every new data point. For example, the model training module 270 identifies and retrieves new data points for the past whole month and incrementally updates the previous model.

Referring now to FIG. 3, an embodiment of a prediction server 108 will be described in more detail. The prediction server 108 comprises a processor 302, a memory 304, a display module 306, a network I/F module 308, an input/output device 310, and a storage device 312 coupled for communication with each other via a bus 320.

Those skilled in the art will recognize that some of the components of the prediction server 108 have the same or similar functionality as the components of the training server 102 so descriptions of these components will not be repeated here. For example, the processor 302, the memory 304, the display module 306, the network I/F module 308, the input/output device 310, the bus 320, etc. are similar to those described above with reference to FIG. 2.

As depicted in FIG. 3, the scoring unit 116 may include and may signal the following to perform their functions: a scorer module 350, a monitoring module 360 and a model swapping module 370.

The scorer module 350 includes computer logic executable by the processor 302 to import a portable model from the training server 102 and to load the portable model in the prediction server 108 for scoring predictions. In some implementations, the scorer module 350 is coupled to the storage device 312 to access one or more imported DAGs of transformation workflows, model data, etc. In some implementations, the scorer module 350 receives/retrieves imported transformation workflow and model data from the plurality of third party servers 122a . . . 122n for deploying at the prediction server 108 for scoring predictions.

In some implementations, the scorer module 350 receives the portable model from the training server 102 and stores the portable model in the storage device 312 for presentation in a list of portable models. The scorer module 350 may receive more than one portable model from the training server 102 at a given time. In some implementations, the one or more portable models may be exported from the training server 102 by different users and/or different projects under different security and access constraints.

The scorer module 350 may receive a new or updated portable model when an existing portable model is deployed for scoring predictions at the prediction server 108. In some implementations, the scorer module 350 checks whether a name of the transformation workflow in the new portable model matches the name of the transformation workflow in an existing portable model stored in the storage device 212. If the names match, the scorer module 350 archives the existing portable model by archiving the transformation workflow and PMML file of the model in the storage device 212. The scorer module 350 imports the new portable model by importing the transformation workflow (including custom user transformations) and the PMML file of the model subsequent to archiving the existing portable model.

In some implementations, the scorer module 350 receives one or more new portable models when an existing portable model is deployed for scoring predictions at the prediction server 108. The scorer module 350 may receive a selection from the user to perform a warm deployment of the one or more new portable models in the prediction server 108. In the warm deployment, the one or more portable models do not swap with the existing portable model that is currently scoring predictions at the prediction server 108. The one or more portable models run in a similar live setting for the user to observe the behavior of the portable models over a period of time. For example, the scorer module 350 sends instruction to the monitoring module 360 to gather statistics on the warm deployment of the one or more portable models. The monitoring module 360 is described in detail below. The monitoring module 360 reports to the scorer module 350 the accuracy of the one or more portable models. The scorer module 350 identifies the one or more portable models as challenger models to the existing portable model which is the champion model currently scoring predictions at the prediction server 108. In some implementations, the scorer module 350 receives a selection of one of the one or more portable models to swap with the existing portable model to become the champion and score predictions at the prediction server 108. For example, the user observes that the new portable model is outperforming the existing portable model in deployment in statistics including but not limited to accuracy, prediction time, etc. and the user selects the new portable model for deployment.

In some implementations, the scorer module 350 receives one or more portable models in training from the training server 102. As part of model training, the scorer module 350 receives a request to determine whether the scoring time for the one or more portable models in training meets a certain Service Level Agreement (SLA) by performing a warm deployment. The scorer module 350 performs a warm deployment of the one or more portable models at the prediction server 108 and instructs the monitoring module 360 to measure the scoring time. In some implementations, the scorer module 350 receives the scoring time metrics for the one or more portable models from the monitoring module 360 and selects the portable model with the best scoring time SLA. In other implementations, the scorer module 350 may receive a request to perform analysis on whether the one or more portable models meet a SLA for a different statistic other than scoring time. For example, the statistic could include but not limited to rate of prediction, transformation time duration, time latency delta, etc.

In some implementations, the scorer module 350 receives a user selection of a portable model from the list of portable models for deployment to score predictions on a live stream of data points (whether received individually or as part of a batch). For real time scoring, it is important to distinguish between the different portable models. For example, a portable model may be identified by a workflow ID specific to the workflow and the model.

In some implementations, the scorer module 350 receives information from the user for deploying the portable model for scoring predictions at the prediction server 108. The scorer module 350 may receive a selection of columnar data output for each scoring request that is to be processed by the portable model. For example, the selected columnar data may include ID, probability, label, etc. In some implementations, the scorer module 350 may receive information from the user for setting a trained classification objective for the portable model (e.g., F-score, classification accuracy or any other objective). In other implementations, the scorer module 350 may receive a probability threshold for scoring from the user. The PMML file of the model that was imported by the scorer module 350 may include the probability threshold that was determined during training of the model. For example, classification models make use of the probability threshold to identify the predicted class. The probability threshold can be modifiable by the user which allows the user to tune the portable model for deployment at the prediction server 108. In some implementations, the scorer module 350 receives a selection of a number of data points to be batched together for the portable model to start scoring. This may be done to increase throughput and decrease individual scoring time. In some implementations, the scorer module 350 receives a selection of a time interval between the scoring batches of data points. In some implementations, the scorer module 350 may invoke a scoring run when either one of the number of data points meets a batch size first or the time interval between the scoring batches is reached first. In some implementations, the selection of the number of data points to be zero may lead to point-by-point scoring (i.e. no batching).

In some implementations, the scorer module 350 receives a single data point and validates the single data point. For example, the scorer module 350 checks whether the data format of the data point matches the starting transformation(s) of the workflow associated with the deployed portable model. The scorer module 350 invokes the transformation operations defined in the transformation workflow and transforms the data point into the format expected at the input of the model. The scorer module evaluates the model on the transformed data point and identifies the output produced by the model. This output can be, for example, a regression value or a class prediction depending on the type of the model. In the implementation where the output is a class prediction, the output may be a numerical representation of the class as defined at the time of training of the model at the training server 102. In other implementations, the scorer module 350 receives a collection of data points in a batch file and the scorer module 350 wraps the file into a stream object for scoring by the portable model. In some implementations, the scorer module 350 receives different types of data points and validates the different types of data points. For example, in the case where the portable model includes a transformation workflow with two or more starting transformation that lead up to the endpoint of the model, the scorer module 350 checks whether the data format of the different data points matches the specified starting transformation from the multiple starting transformations of the workflow associated with the deployed portable model.

In some implementations, the scorer module 350 receives a request to prepare the transformation workflow of the portable model prior to the deployment at the prediction server 108. For example, certain transformation(s) in the transformation workflow may require a substitution of the dataset (carried from the training server 102) with active and dynamic datasets to improve relevance of scoring at the prediction server 108. The scorer module 350 implements the dataset substitution accordingly.

In some implementations, the scorer module 350 may deploy concurrently multiple portable models in the prediction server 108 to handle large scoring request volumes. For example, there may be need for portable models to predict different features at the prediction server 108. Portable model A may predict feature A and portable model B may predict feature B concurrently at the prediction server 108. In another example, consider a hedge fund dataset analysis and the scorer module 350 may run a portable model A for a commodities market and portable model B for a stock market. Portable model A can be independent from portable model B and predict different features concurrently. In some implementations, the scorer module 350 may cluster the deployment of a portable model on multiple servers (considering the prediction server 108 is distributed) for load balancing and high availability. In other implementations, the scorer module 350 may partition the portable model (considering that the portable model is large) and distributed to run on the multiple servers.

In some implementations, the scorer module 350 may receive a request to start and/or stop deployment of the portable model for scoring predictions at the prediction server 108. In other implementations, the scorer module 350 may provide a status relating the deployed portable model. The status for the portable model can include, for example, running, paused, inactive, etc.

The monitoring module 360 includes computer logic executable by the processor 302 to monitor and aggregate statistics during the deployment of the portable models for scoring predictions at the prediction server 108. In some implementations, the monitoring module 360 is coupled to the storage device 312 to store the aggregated statistics for the deployed portable models including transformation workflows and models.

In some implementations, the monitoring module 360 aggregates runtime statistics as the scoring is occurring in the prediction server 108 where one or more deployed models may be scoring predictions. For example, statistics gathered during the deployment of the one or more portable models include but not limited to: a number of data points received, a number of data points scored, a number of data points scored grouped by score, average transformation time duration, maximum transformation time duration, average scoring time duration, maximum scoring time duration, rate of scoring (prediction count/minute or hour or day), distribution of input point values, distribution of output prediction values, time latency delta, input/output count delta, model variable importance of champion model versus newly trained model, etc. In some embodiments, the monitoring module 360 aggregates cumulative statistics since the last portable model deployment. In some implementations, the monitoring module 360 may receive a selection of a period of time from a user and provide statistics for the selected time period along with cumulative statistics to the user.

In some implementations, the statistics aggregated for the one or more deployed portable models provide to the user, for example, an understanding relating to a health of the model, accuracy of the model over time, an estimated time until update of the model, etc. For example, a model for predicting fraud is deployed to the prediction server 108. A common understanding might be that 0.5 percent of the transactions are fraudulent. The monitoring module 360 aggregates the statistics for the fraud detection model that may indicate that the model is flagging only 0.3 percent of the transactions as fraudulent. From the aggregated statistics indicating failing accuracy, the user may arrive at a reasonable conclusion that the model is not current and is failing to predict new fraudulent transactions. In another example, the aggregated statistics indicating a delta in the count of input versus output data, the user may arrive at a reasonable conclusion that the model is receiving new data that it has not encountered before in training and thus cannot make a prediction. Either of which can indicate to the user that updating the model for predicting fraud is important.

In some embodiments, the monitoring module 360 maintains a live updatable scoreboard for portable models deployed for scoring predictions in the prediction server 108. The monitoring module 360 aggregates ground truth for predictions scored by the one or more portable models. The monitoring module 360 determines accuracy metrics that indicates what percentage of those predictions match the ground truth. The monitoring module 360 compares the accuracy metrics for the one or more portable models on a live scoreboard. For example, the monitoring module 360 compares 10 warm deployed portable models that acts as 10 different challengers to the existing portable model deployed in the prediction environment. The live scoreboard acts a monitoring interface that helps the user to observe if any one of the 10 challengers outperform the champion portable model.

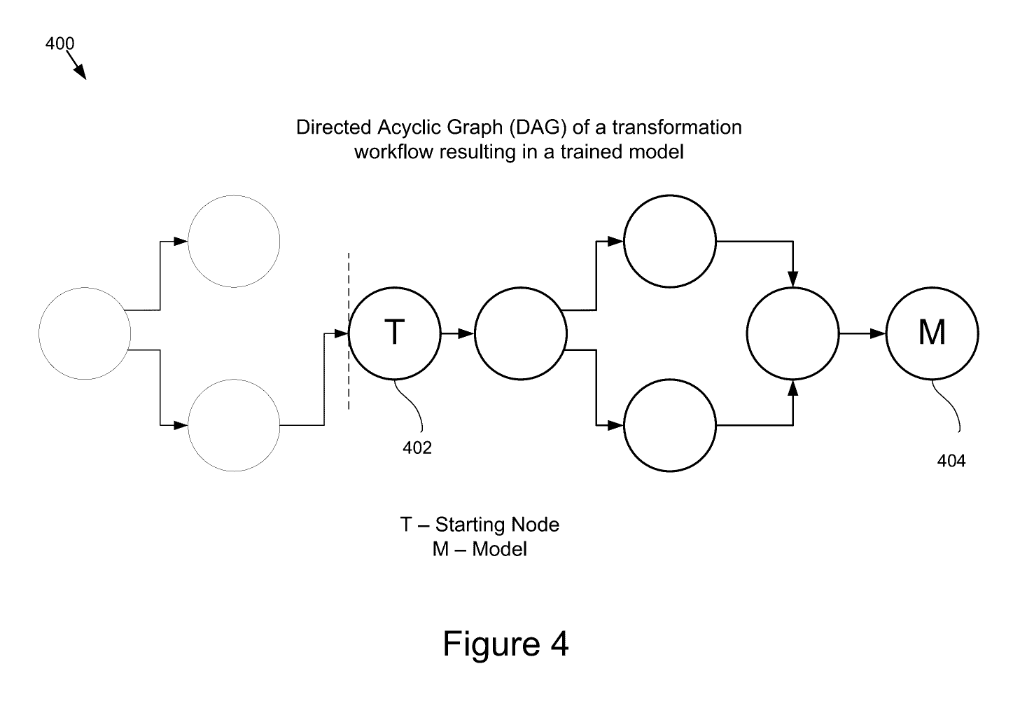

FIG. 4 is a graphical representation of an example of a directed acyclic graph (DAG) 400 representing a transformation workflow, which starts with a data source and produces a trained model. Depending on the embodiment, a node may represent a transformation or an edge may represent a transformation. In the illustrated embodiment, a node of DAG 400 represents transformation (which may, e.g., be a model or an ETL). In the illustrated embodiment, the last node 404 marked M is a model trained using a dataset. In one embodiment, the transformation workflow module 250 receives a user input selecting a node associated with a model the user wishes to deploy into a production environment and another transform represented by a node in the workflow that leads to the node associated with the model as a start node. For example, assuming the user is interested in deploying the model “M” into their production environment, the user may select node 404 in the above workflow select node 402 associated with transform T as the starting point in the DAG. The model export module 260 exports the portion of the DAG beginning at the starting node and ending at the model's node. In the illustrated example, the model export module 260 exports the DAG starting with transform T and includes any intervening transforms on the path(s) to reach the model M. In one embodiment, model export module 260 supports export when multiple start nodes selected (not shown) and the export may include all paths leading from either start node to the model. In one embodiment, a node and its associated transform are not included for export if they are not in the path to the Model. For example, if the node is to the left of node 402 in the illustrated example or if the node is located between node 402 and 404 but does not lead to model M (not shown), the node is omitted from the export. In one embodiment, the model export module 260 exports the PMML corresponding to the model M as well.

In some implementations, a node on the DAG may represent more than one transformations, which may be referred to as sub transformations. For example, in one implementation, node 402 represent multiple data transformations and the user may select node 402 to expand (or zoom into) node 402 and, when this is done, node 402 may be replaced by nodes representing each of the multiple transformations grouped under node 402. For example, assume node 402 represents a feature selection; in one implementation, when 402 is expanded, the DAG may display the iterative process of eliminating columns one at a time, two at a time, and so forth to determine the feature set that results in the most accurate model.

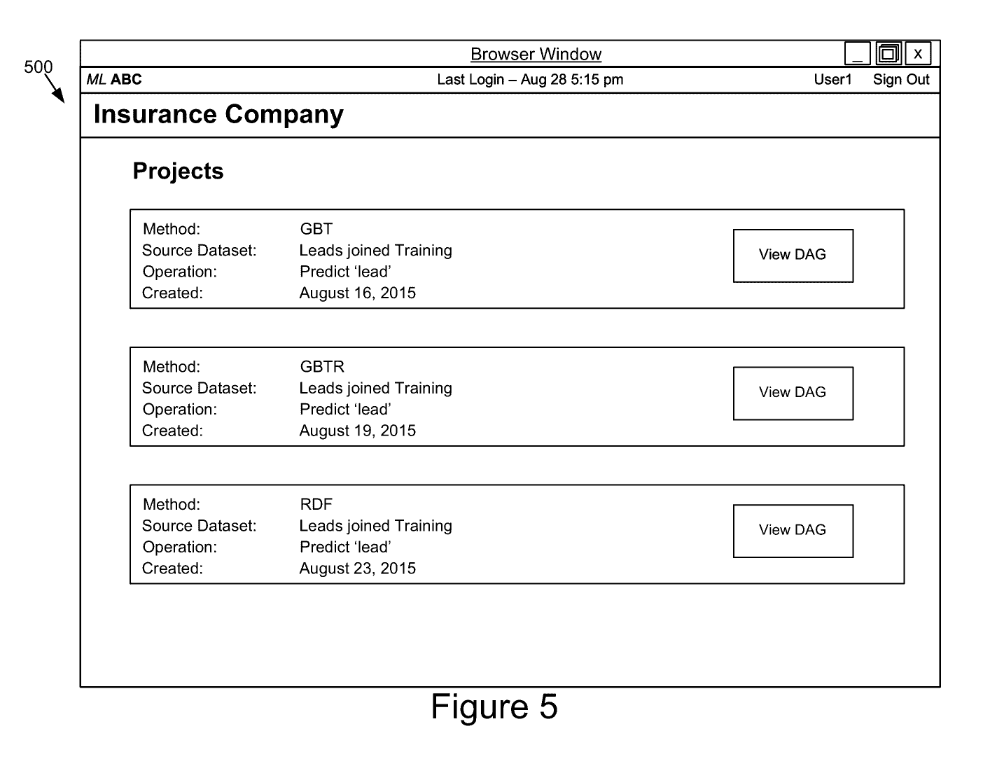

FIG. 5 is a graphical representation of an example of a user interface 500 displaying a list of transformation workflow projects according to one embodiment. In one embodiment, each transformation workflow listed includes one or more transformations invoked on a source dataset and a model trained on the source dataset. In one embodiment, the one or more transformations may include a model (e.g. the output of a first model is used as an input for a second model). In the illustrated embodiment, each project in the list is associated with a machine learning method of the project, a source dataset of the project, an operation and a creation date of the project, which are displayed to a user in the user interface 500. In one embodiment, each project listed is also associated with a graphical element (e.g. button, link, etc.) that, when selected, requests presentation of the DAG of the project associated with the selected graphical element.

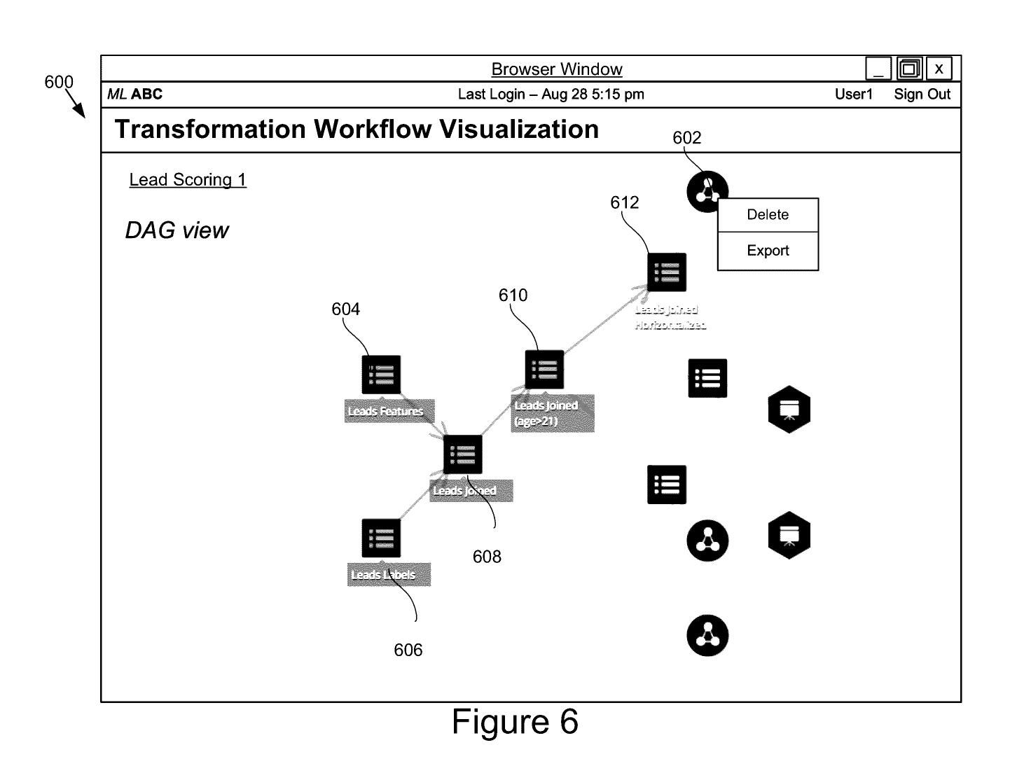

FIG. 6 is a graphical representation of an example of a user interface 600 displaying a directed acyclic graph (DAG) view of a selected transformation workflow according to one embodiment. In one embodiment, the DAG view 600 of FIG. 6 is presented to the user responsive to the selection of a graphical element such as the “View DAG” button illustrated in FIG. 5. In the illustrated DAG view of user interface 600, a user can select on a node associated with a model. For example, assume the user intends to export the model associated with node 602; in one embodiment, the user may right-click on node 602 and select export. In one embodiment, responsive to the selection of a model for export (e.g. node 602), the nodes associated with transformations that lead to the selected model (604, 606, 608, 610, 612) are visually distinguished. For example, in the illustrated embodiment, nodes 604, 606, 608, 610, 612 and the edges connecting them are highlighted. In the illustrated embodiment, information about the transformation represented by each highlighted node is also displayed (e.g. node 608 is labeled with a “Leads Joined” label. Such visual distinction may beneficially allow a user to identify one or more valid, potential start points. Depending on the embodiment, the user may select one or more start nodes graphically (e.g. by right clicking on a highlighted node in the user interface 600, identifying a highlighted node by name (or another identifier) in another user interface such as user interface 700 discussed below with reference to FIG. 7, or a combination thereof.

FIG. 7 is a graphical representation of an example of a user interface 700 for creating an exportable model according to one embodiment. In the illustrated embodiment, a user provides a name for the portable model (i.e. the model to be exported to production), the one or more start nodes, an end node and an export path. In some embodiments, the user may provide additional information. In one embodiment, the information is obtained based on the user's interaction with the DAG of user interface 600. For example, the model export module 260 auto-populates the field for the end node based on the model node 602 selected for export in user interface 600, and auto-populates the field for one or more start nodes in user interface 700 based on a user's selection of one or more start nodes in the DAG view of user interface 600. In one embodiment, the model export module 260 presents the user with the option to perform a validation check on the portion of the workflow that the user intends to export (e.g. by selecting an associated graphical element such as a link or button). In one embodiment, the model export module 260 presents the user with the option to export the model as Predictive Model Markup Language (PMML) (e.g. by selecting an associated graphical element such as a link or button).

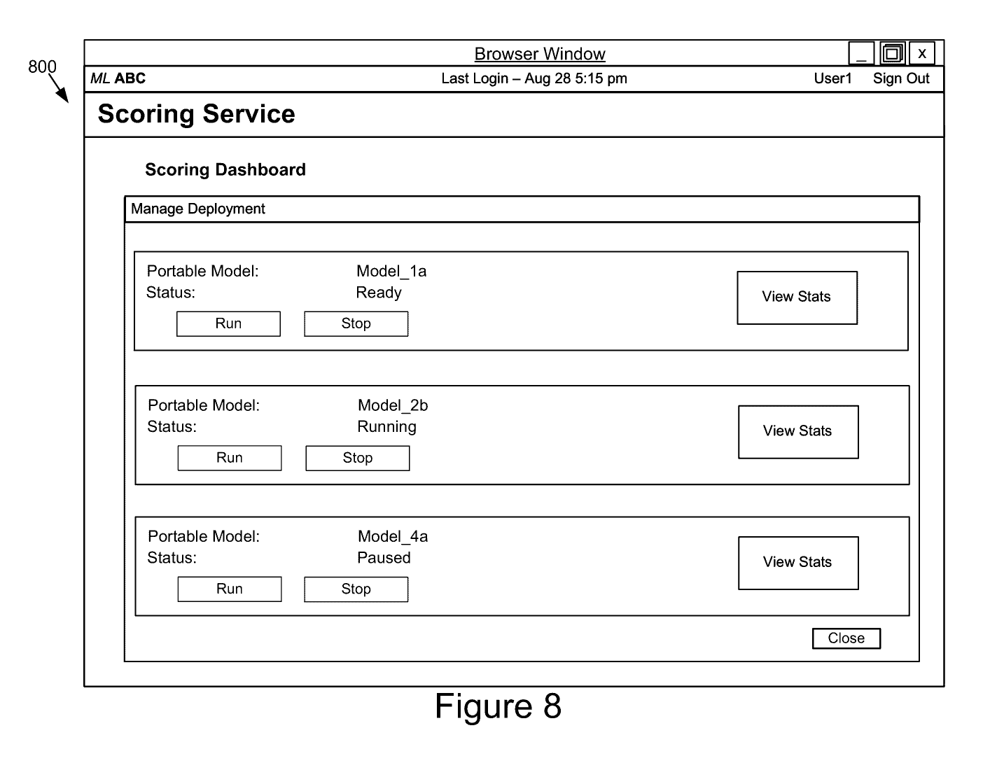

FIG. 8 is a graphical representation of an example of a user interface 800 displaying a scoring dashboard according to one embodiment. In the illustrated embodiment, the scoring dashboard displays a list of the models that have been deployed in the production environment (e.g. prediction server 108). In one embodiment, the list displays information associated with each of the deployed models including, but not limited to, the name of the model, the status of the model, one or more graphical elements for modifying the status of the model and execution statistics (e.g. number of points received, number of points scored, number of points scored grouped by score, average transformation time duration, max transformation time duration, average scoring time duration, max scoring time duration, etc) associated with the model and/or a graphical element that when selected results in the presentation of execution statistics of the associated model. Depending on the embodiment, the execution statistics may be for one or more periods of time (e.g. since deployment and/or for a specified period of time such as the last 30 days, etc.) or may be presented in real time for a selected time frequency (minute, hour, day, etc.).

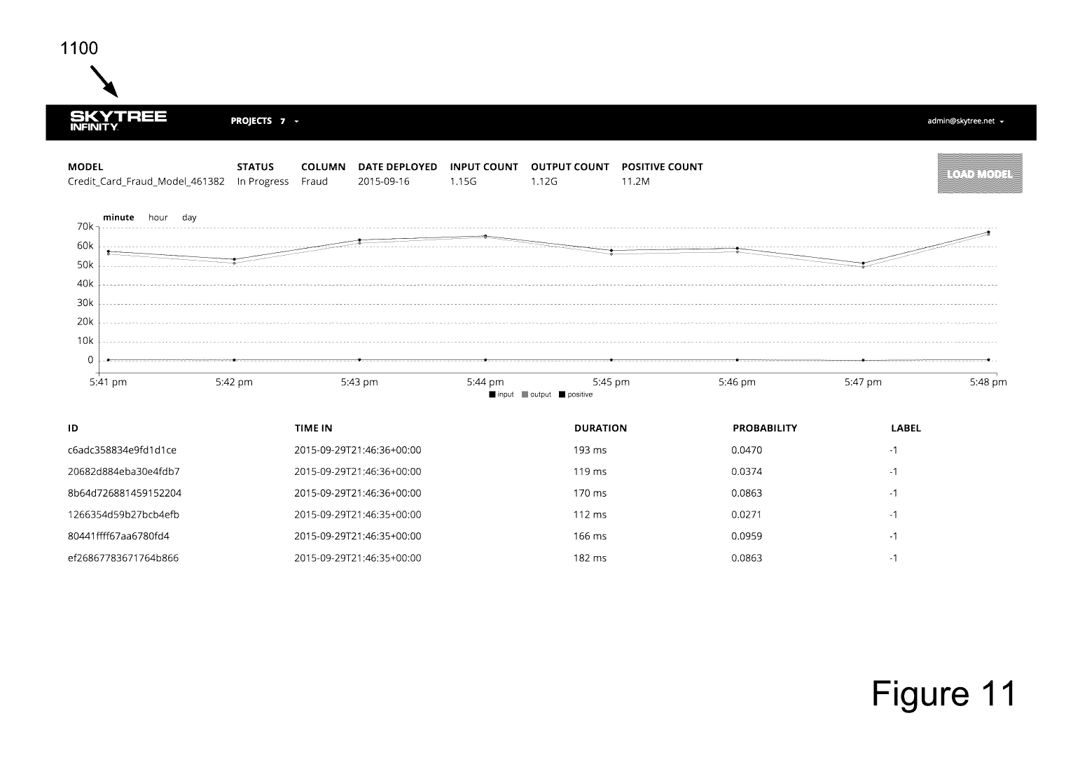

FIG. 11 is a graphical representation of an example of a user interface 1100 displaying a scoreboard according to one embodiment. In one embodiment, the user interface 1100 is presented to the user responsive to the user selecting a “View Stats” button in user interface 800.

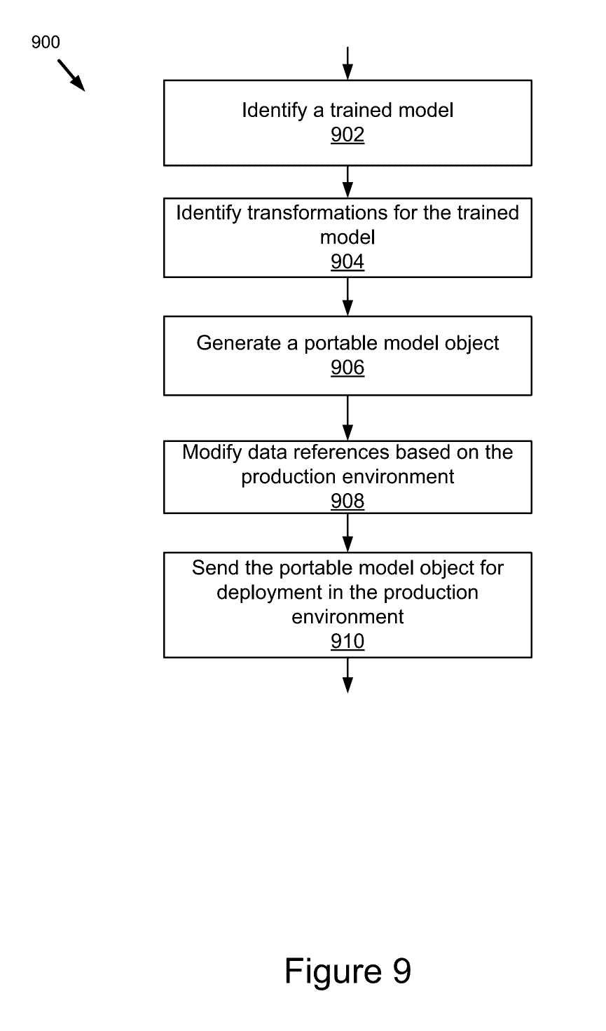

FIG. 9 is a flowchart of an example method for exporting of a portion of a transformation chain including an endpoint of a trained model to a production environment for prediction according to one embodiment. At 902, the model export module 260 identifies a trained model (e.g. an end node selected by the user and received from the transformation workflow module 250). At 904, the model export module 260 identifies the transformation(s) for the trained model (e.g. the one or more start nodes and any intervening nodes received from the transformation workflow module 250). At 906, the model export module 260 generates a portable model object. At 908, the model export module 260 modifies the data references based on the production environment (e.g. so that the input refers to the data source of the production environment rather than the data source for training data). At 910, the model export module 260 sends the portable model object for deployment in the production environment.

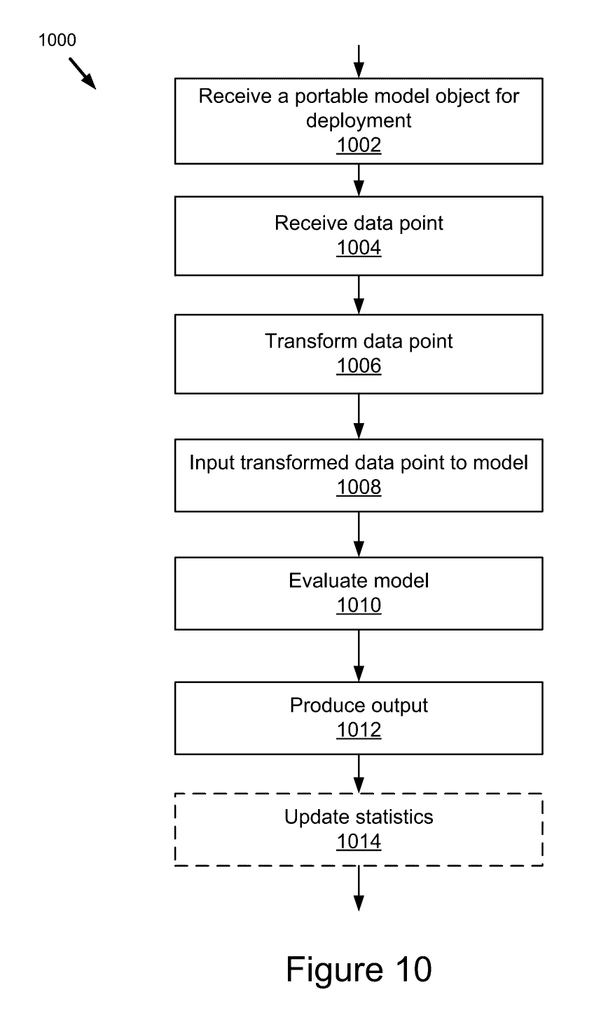

FIG. 10 is a flowchart of an example method 1000 for deploying a transformation chain including an endpoint of a trained model in a production environment for prediction according to one embodiment. At 1002, the scorer module 350 receives a portable model object for deployment. At 1004, the scorer module 350 receives a data point. At 1006, the scorer module 350 transforms the data point based on the transforms of the portable model object received at 1002. At 1008, the scorer module 350 inputs the transformed data point into the model from the portable model object. At 1010, the scorer module 350 evaluates the model using the transformed data point and, at 1012, produces an output (e.g. a prediction or classification). At 1014, the monitoring module 360 updates the statistics associated with the deployed portable model object.

It should be understood that while FIGS. 9-10 include a number of steps in a predefined order, the methods may not perform all of the steps or perform the steps in the same order. The methods may be performed with any combination of the steps (including fewer or additional steps) different than that shown in FIGS. 9-10. The methods may perform such combinations of steps in any other orders.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A method comprising:
sending, using one or more processors, for presentation, to a user, a directed acyclic graph representing a model trained using a transformed source dataset and one or more transformations used to obtain the transformed source dataset;
determining, using the one or more processors, the model as an endpoint based on a user selection;
determining, using the one or more processors, a transformation as a start point;
determining, using the one or more processors, whether one or more intervening transformations exist on a path going from the start point and leading to the endpoint in the directed acyclic graph; and
exporting, using the one or more processors, the model and relevant transformations, the relevant transformations including the transformation at the start point and any intervening transformations on the path going from the start point and leading to the model at endpoint in the directed acyclic graph to a production environment.

2. The method of claim 1, wherein the model and the relevant transformations are converted, as part of the export process, to real-time streaming.

3. The method of claim 1, wherein the model is trained in batch mode and the production environment operates in one of batch mode and real-time streaming mode.

4. The method of claim 1, wherein the model and relevant transformations including the transformation at the start point and any intervening transformations on the path going from the start point and leading to the model at endpoint in the directed acyclic graph is less than the entirety of a workflow represented by the directed acyclic graph.

5. The method of claim 1, including validating one or more of the relevant transformations.

6. The method of claim 1, including validating a precondition and post condition of the transformation of each relevant transformation.

7. The method of claim 1 comprising:
determining an additional transformation as an additional start point;
determining whether one or more additional, intervening transformations exist on a path going from the additional start point and leading to the endpoint in the directed acyclic graph; and
wherein the relevant transformations that are exported include the additional start point and any additional, intervening transformations leading from the additional start point to the model at the endpoint.

8. The method of claim 1 comprising:
determining a subset of variables associated with one or more of a first transformation, an intervening transformation and a model that should be fixed for use in the production environment; and
setting the variable to the fixed value when exporting the model and relevant transformations.

9. A system comprising:
one or more processors; and
a memory storing instructions that, when executed by the one or more processors, cause the system to:
send for presentation, to a user, a directed acyclic graph representing a model trained using a transformed source dataset and one or more transformations used to obtain the transformed source dataset;
determine the model as an endpoint based on a user selection;
determine a transformation as a start point;
determine whether one or more intervening transformations exist on a path going from the start point and leading to the endpoint in the directed acyclic graph; and
export the model and relevant transformations, the relevant transformations including the transformation at the start point and any intervening transformations on the path going from the start point and leading to the model at endpoint in the directed acyclic graph to a production environment.

10. The system of claim 9, wherein the model and the relevant transformations are converted, as part of the export process, to real-time streaming.

11. The system of claim 9, wherein the model is trained in batch mode and the production environment operates in one of batch mode and real-time streaming mode.

12. The system of claim 9, wherein the model and relevant transformations including the transformation at the start point and any intervening transformations on the path going from the start point and leading to the model at endpoint in the directed acyclic graph is less than the entirety of a workflow represented by the directed acyclic graph.

13. The system of claim 9, the instructions causing the system to validate one or more of the relevant transformations.

14. The system of claim 9, the instructions causing the system to validate a precondition and post condition of the transformation of each relevant transformation.

15. The system of claim 9, wherein the instruction cause the system to:
determine an additional transformation as an additional start point;
determine whether one or more additional, intervening transformations exist on a path going from the additional start point and leading to the endpoint in the directed acyclic graph; and
wherein the relevant transformations that are exported include the additional start point and any additional, intervening transformations leading from the additional start point to the model at the endpoint.

16. The system of claim 9, wherein the instruction cause the system to:
determine a subset of variables associated with one or more of a first transformation, an intervening transformation and a model that should be fixed for use in the production environment; and
set the variable to the fixed value when exporting the model and relevant transformations.

17. A computer program product comprising a computer usable medium including a computer readable program, wherein the computer readable program when executed on a computer causes the computer to:
send for presentation, to a user, a directed acyclic graph representing a model trained using a transformed source dataset and one or more transformations used to obtain the transformed source dataset;
determine the model as an endpoint based on a user selection;
determine a transformation as a start point;
determine whether one or more intervening transformations exist on a path going from the start point and leading to the endpoint in the directed acyclic graph; and
export the model and relevant transformations, the relevant transformations including the transformation at the start point and any intervening transformations on the path going from the start point and leading to the model at endpoint in the directed acyclic graph to a production environment.

18. The computer program product of claim 17, wherein the model and the relevant transformations are converted, as part of the export process, to real-time streaming.

19. The computer program product of claim 17, wherein the model is trained in batch mode and the production environment operates in one of batch mode and real-time streaming mode.

20. The computer program product of claim 17, wherein the model and relevant transformations including the transformation at the start point and any intervening transformations on the path going from the start point and leading to the model at endpoint in the directed acyclic graph is less than the entirety of a workflow represented by the directed acyclic graph.
